(19) United States
(12) Patent Application Publication
(10) Pub. No.: US 2005/0066733 A1
(43) Pub. Date: Mar. 31, 2005

(54) System and method for detecting hydrogen concentration in a metal object

(76) Inventors: Che-Hua Yang, Sindian City (TW); Ming-Fong Huang, Taipei City (TW)

Correspondence Address: Eric D. Cohen;Welsh & Katz, Ltd., 22nd Floor, 120 South Riverside Plaza, Chicago, IL, 60606, US

(21) Appl. No.: 10/945,665

(22) Filed: Sep. 21, 2004

(30) Foreign Application Priority Data
Sep. 26, 2003 (TW) 92126746

(51) Int. Cl. G01N 29/00

(52) U.S. Cl. 73/627

(57) ABSTRACT

A system and method for detecting hydrogen concentration of a metal object is provided. The system includes a water tank, a transducer and an electronic device. The water tank contains coupling fluid for submerging the metal object. The transducer is located aside the metal object for transmitting ultrasonic pulse signals to the metal object and receiving the reflective ultrasonic pulse signals from the metal object. The electronic device is connected to the transducer and stores a processing program for controlling the transmission and receiving of ultrasonic pulse signals of the transducer. The electronic device changes the relative distance between the metal object and the transducer. When receiving the ultrasonic pulse signals under a predetermined distance, the electronic device processes the pulse signals with the processing program through double fast Fourier Transform to obtain hydrogen concentration of the metal object.

### FIELD OF THE INVENTION

The invention relates to a system and method of detecting hydrogen concentration of a metal object, and particularly relates to a system and method for detecting hydrogen concentration of a metal object by applying acoustic microscope microscope.

### BACKGROUND OF THE INVENTION

In the operating process of a heavy water circulatory system in nuclear power industry, because of the hydrogen embrittlement caused by neutron irradiation and corrosion reaction of the circulating water, the metal components (usually made of Zircaloy) used in the heavy water circulatory system easily get hydrogen embrittlement, change the fracture toughness and other mechanical properties and influence the structural safety and reliability of the nuclear power system when the hydrogen content concentration reaching a marginal value. Started from the years around 1950, researchers discovered that the hydrogen concentration in the metal affects the ductility of the metal and reduce its fracture toughness. Therefore, some technologies to detect the hydrogen concentration in metal are developed. These technologies include inert-gas fusion, hot-vacuum extraction method, quantitative metallographic and so on. However, using these technologies spends much time and cost.

In view of the above problem, researchers are trying to develop new methods that spend less time and cost. However, the methods of prior developments get larger deviations, and are unable to detect a small concentration of hydrogen content.

### SUMMARY OF THE INVENTION

The object of the invention is to provide a system and method for detecting hydrogen concentration in a metal object in a non-contact manner and with enhanced accuracy.

The system and method for detecting hydrogen concentration in a metal object according to the invention includes a water tank, a transducer and an electronic device. The water tank stores a coupling fluid for submerging the metal object. The transducer is located aside the metal object for transmitting ultrasonic pulse signals to the metal object and receiving the reflective ultrasonic pulse signals from the metal object. The electronic device is connected to the transducer and stores a processing program for controlling the transmission and receiving of ultrasonic pulse signals of the transducer. The electronic device changes the relative distance between the metal object and the transducer. When receiving the ultrasonic pulse signals under a predetermined distance, the electronic device processes the pulse signals with the processing program through double fast Fourier Transform to obtain hydrogen concentration of the metal object. Therefore, the invention detects hydrogen concentration in the metal object in a non-contact manner and with enhanced accuracy. It avoids high temperature working conditions and avoids injury of radiation to human bodies.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is a systematic diagram of the invention;

FIG. 2 is a schematic diagram of frequency to relative amplitude of the transducer in the invention;

FIG. 3 is a schematic time to amplitude diagram of a metal object having a hydrogen concentration of zero millionth (less than one millionth);

FIG. 4 is a B-SCAN image of time to relative distance between the metal object and the transducer;

FIG. 5 is a dispersion curve of a metal object without hydrogen content;

FIG. 6 is a schematic diagram including dispersion curves of metal objects with different hydrogen concentrations;

FIG. 7 is a schematic diagram of hydrogen concentration to phase velocity under a fixed operating frequency;

FIGS. 8A, 8B, 9, 10A, 10B and 11 are flowcharts of a method of the invention; and

FIG. 12 is the hydrogen concentration data of the metal objects in the axial direction which are divided into 5 parts as H1, H2, H3, H4, and H5.

### DETAILED DESCRIPTION OF THE INVENTION

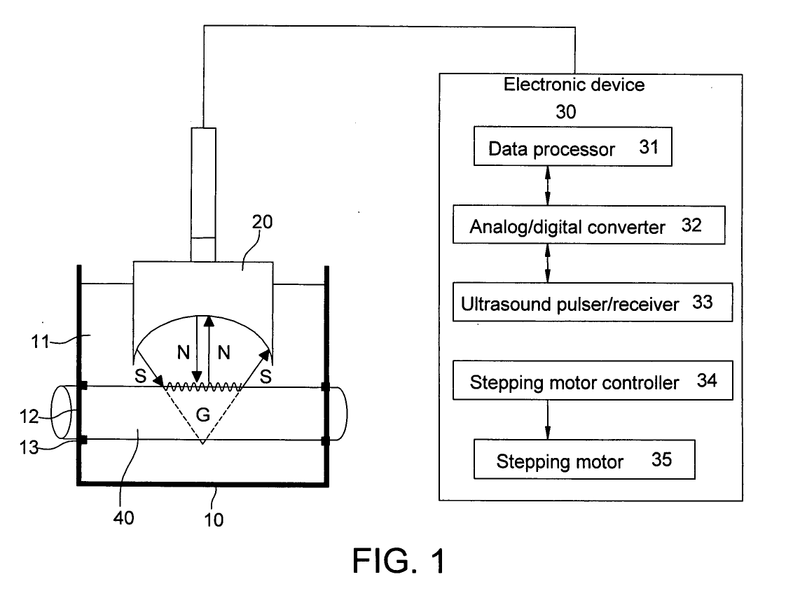

In the operating process of a nuclear power industry, because of the hydrogen embrittlement caused by neutron irradiation and corrosion reaction of the circulating water, the metal components 40 (as shown in FIG. 1 and usually made of Zircaloy) used in the heavy water circulatory system easily get hydrogen embrittlement, change the fracture toughness and other mechanical properties and influence the structural safety and reliability of the nuclear power system when the hydrogen content concentration reaching a marginal value.

The invention provides a system and method for detecting hydrogen concentration in a metal object. As shown in FIG. 1, the system includes a water tank 10, a transducer 20 and an electronic device 30.

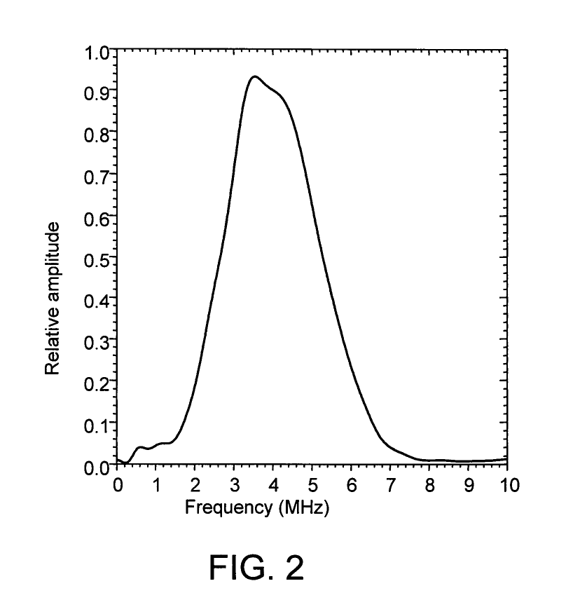

The water tank 10 stores a coupling fluid 11 for surrounding the metal object 40. The transducer 20 is a line-focused-beam transducer made of polyvinylidene fluoride (PVDF) piezoelectric membrane. The focus length is about 15 to 25 millimeters. The frequency is within 1 to 10 million Hertz and has a central frequency around 3.5 million Hertz (please refer to FIG. 2, a schematic diagram of frequency to relative amplitude of the transducer). The transducer 20 is correspondingly placed above the metal object 40 for transmitting and receiving ultrasonic pulse signals, and being movable among several measuring positions of predetermined distances.

The electronic device 30 connects with the transducer 20 and includes a data processor 31, an analog/digital converter (ADC) 32, an ultrasound pulser/receiver 33, a stepping motor controller 34 and a stepping motor 35. The data processor 31 stores a processing program for processing the data. The analog/digital converter 32 is connected to the data processor 31 for transforming the received supersonic pulse signal into digital and analog forms and transferring the signals. The ultrasound pulser/receiver 33, analog/digital converter 32 and the transducer 20 are linked for managing the ultrasonic pulse signals. The stepping motor controller 34, the stepping motor 35 and the data processor 31 are connected for controlling the stepping motor 35. The stepping motor 35 moves the receiver 20 to the predetermined positions and changes the relative distance of the transducer 20 to the metal object 40.

Therefore, the ultrasonic pulse signals generated by the data processor 31 of the electronic device 30 are transformed by the analog/digital converter 32 and transmitted by the ultrasound pulser/receiver 33 to the transducer 20. The coupling fluid 11 in the water tank 10 transfers the ultrasonic pulse signals to the metal object 40. The ultrasonic pulse signals reflected by the metal object 40 are transferred to the transducer 20 via the coupling fluid 11. The ultrasound pulser/receiver 33 transfers the reflected signals to the analog/digital converter 32 for transformation, and passes the data to the data processor 31 for confirming the hydrogen concentration of the metal object 40.

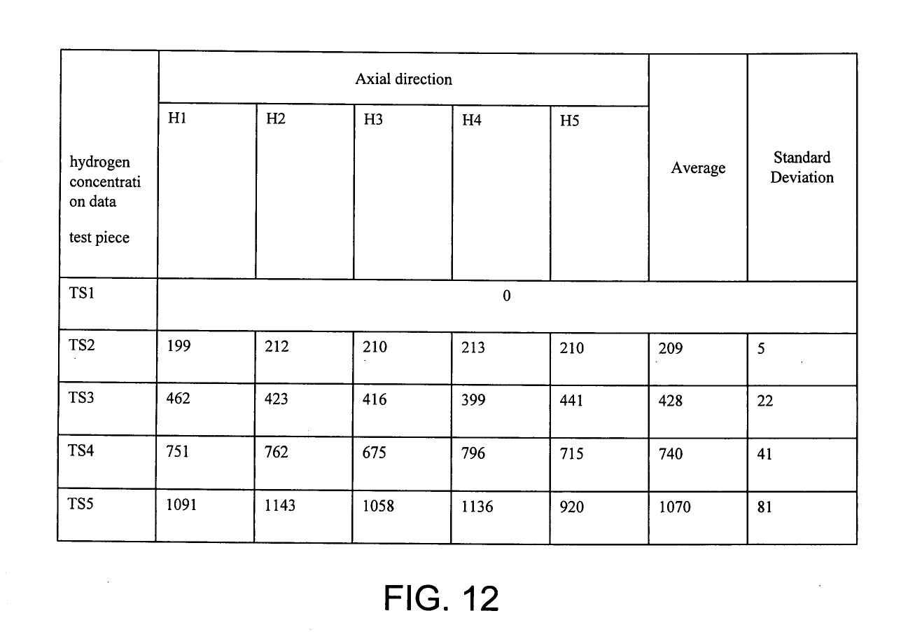

The relationship between hydrogen concentration and the sound reflection as well as the process of the data processor 31 are described below. First, prepare tubular Zircaloy metal objects 40 with diameter of 10.8 mm and wall thickness of 0.64 mm. Five metal objects each has hydrogen concentration of zero millionth (test piece 1; TS1), 200 millionth (test piece 2; TS2), 500 millionth (test piece 3; TS3), 800 millionth (test piece 4; TS4) and 1200 millionth (test piece 5; TS5) respectively. The hydrogen concentration data of the metal objects in the axial direction are divided into 5 parts as H1, H2, H3, H4, and H5, and are listed in FIG. 12.

The ultrasonic pulse signals generated by the data processor 31 of the electronic device 30 are transformed by the analog/digital converter 32 and transmitted by the ultrasound pulser/receiver 33 to the transducer 20. The coupling fluid 11 in the water tank 10 transfers the ultrasonic pulse signals to the metal object 40. The coupling fluid 11 is accommodated to the metal object 40.

As shown in FIG. 1, the transducer 20 transfers the ultrasonic pulse signals directly via the coupling fluid 11 along a NN path to the metal object 40. The reflective pulse signals reflected from the metal object 40 to the transducer 20 are transferred via the coupling fluid 11 in the original path. To check a critical angle of the material, the transducer 20 transmits a guide wave of ultrasonic pulse signal along the metal object 40. The guide wave moves via the coupling fluid 11 to the transducer 20 along a SGS path. The ultrasonic pulse signals received by the transducer 20 are influenced by interference of the ultrasonic pulse signals moving along the NN and SGS paths.

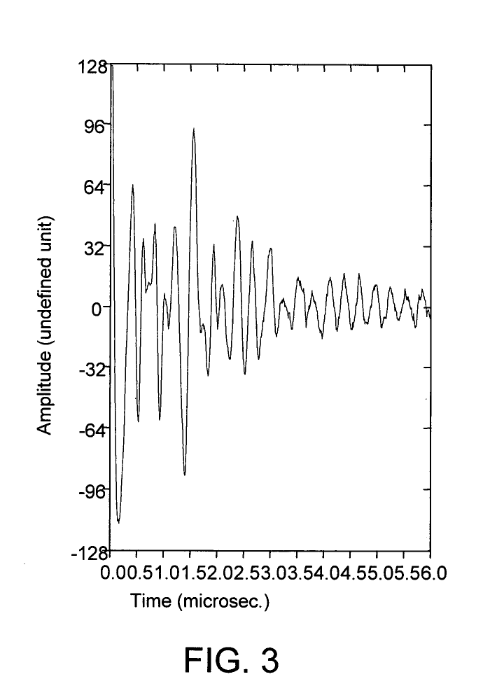

The ultrasound pulser/receiver 33 feedbacks the ultrasonic pulse signals to the analog/digital converter 32 for converting the ultrasonic pulse signals into data. At the data processor 31, the data are stored as a V(z) curve. FIG. 3 shows a schematic time to amplitude diagram of a metal object having a hydrogen concentration of zero millionth (less than one millionth). The time axis of the V(z) curve starts from that the transducer 20 receives ultrasonic pulse signals along the NN path. However, because the V(z) curve includes several ultrasonic wave modes, we cannot separate singular ultrasonic wave mode of the metal object 40 from just a curve V(z). Therefore, we need several V (z) curves for the data processor 31 to process and obtain the singular ultrasonic wave modes.

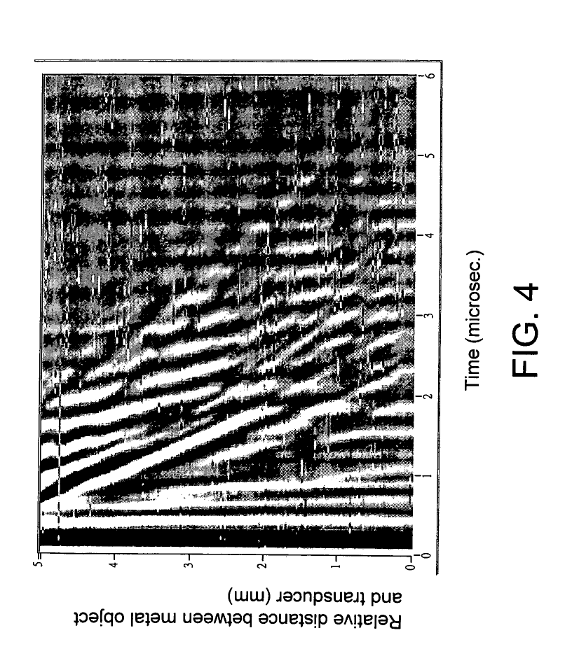

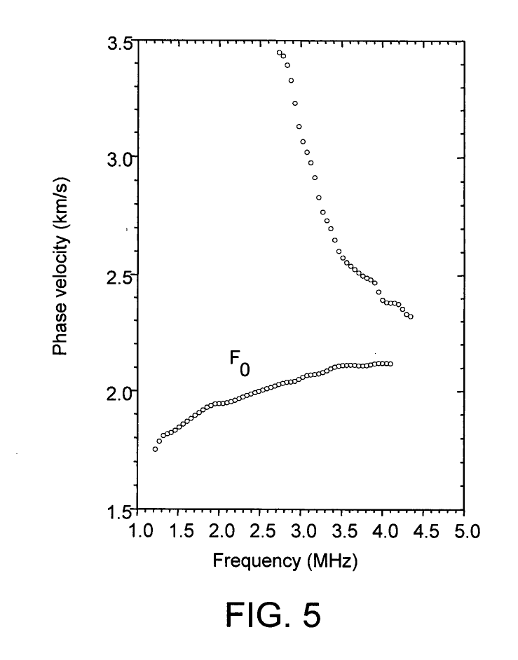

When changing the relative distance between the transducer 20 and the metal object 40, the ultrasonic pulse signals moving along the NN path and the SGS path get different travel lengths that cause the ultrasonic pulse signals on the two paths to have enhancing or counteractive interference so as to produce variant V(z) curves. The curves are provided to the data processor in 31 and stocked into a B-scan data in the data processor 31. FIG. 4 is a B-SCAN image of time to relative distance between the metal object 40 and the transducer 20. The stepping motor 35 moves away 5 mm from the metal object 40 by 200 steps. The abscissa axis represents time, the ordinate axis represents relative distance of the transducer 20 to the metal object 40. The grayscale represents amplitude of the ultrasonic pulse signals. The data processor 31 processes the B-SCAN data with double fast Fourier Transform (Double FFT). The first fast Fourier Transform relates to time transformation. The second fast Fourier Transform relates to transformation of relative distance of the transducer 20 to the metal object 40. The transformations obtain a dispersion of curve of guided waves along the metal object 40. FIG. 5 is a dispersion curve of a metal object without hydrogen content. The ordinate axis represents phase velocity. The abscissa axis represents frequency. The foundation ultrasonic guided waves mode F0 contains most ultrasonic waves energy transmitted by the transducer 20. Therefore, the ultrasonic guided waves modes of different hydrogen concentrations of the metal object 40 can be obtained.

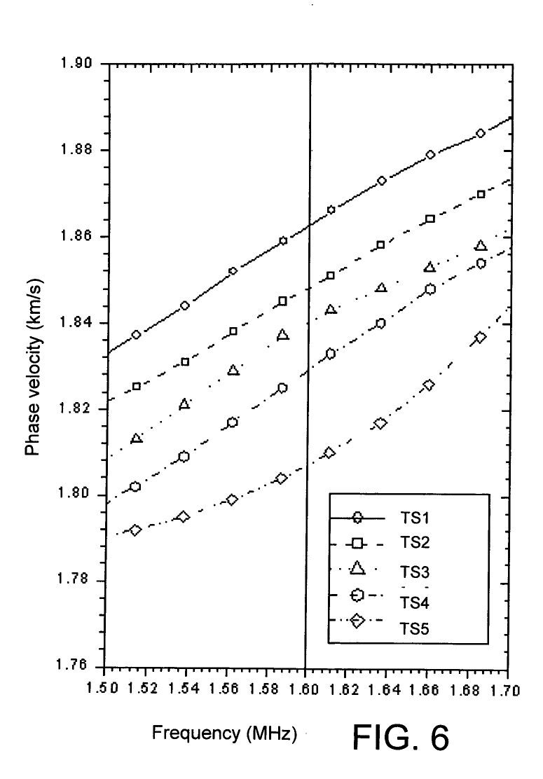

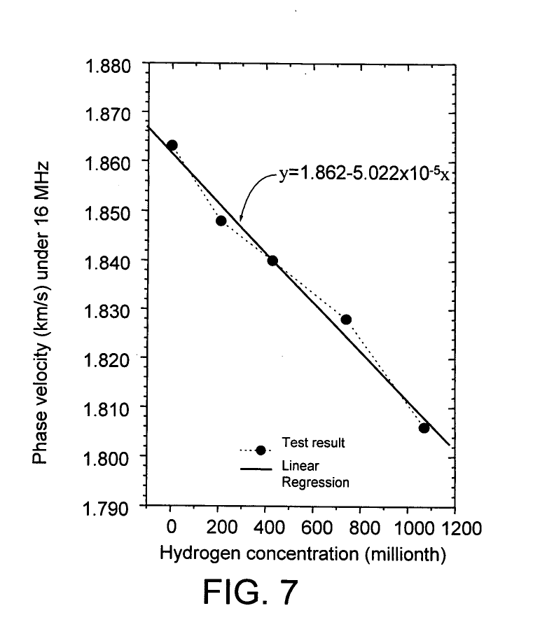

FIG. 6 is a schematic diagram including dispersion curves of metal objects with different hydrogen concentrations. It shows that when the hydrogen concentration of the metal object increases, the phase velocity of the dispersion curve drops, and the ductility of the metal object 40 also drops. The data processor 31 is operated with a frequency as a fixed operating frequency. In the drawing, the fixed operating frequency is 1.6 million Hertz. By the correspondent phase velocity, the hydrogen concentration datum is obtained. As shown in FIG. 7, a schematic diagram of hydrogen concentration to phase velocity under a fixed operating frequency, under the fixed operating frequency, when the phase velocity drops, the hydrogen concentration of the metal object 40 rises linearly. The negative slope shown in the drawing in is 5.022*10−3 kilometer per millionth. In other words, in the dispersion curve of a metal object 40, the foundation ultrasonic guided wave mode under a fixed operating frequency of 1.6 million Hertz, when the hydrogen concentration increases one hundred millionths, the phase velocity drops 5.022 meter per second. Therefore, hydrogen concentration of the metal object 40 can be obtained from the phase velocity to oxygen concentration relations as the data processor 31 obtains the phase velocity of the metal object 40.

Thus the invention enhances the accuracy of detecting hydrogen concentration of metal object through a non-contact manner. It avoids high temperature contacts and avoids radiation injury to human bodies.

As shown in FIG. 1, the water tank 10 is formed with a hole 12 and fixtures 13 for fixing the metal object 40. The system of the invention can be made into a portable device or others.

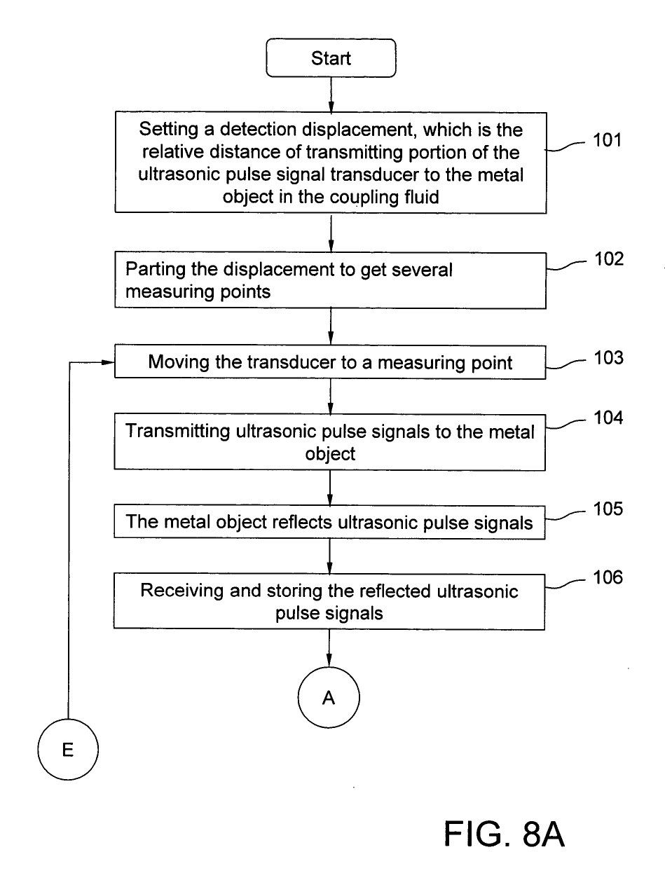

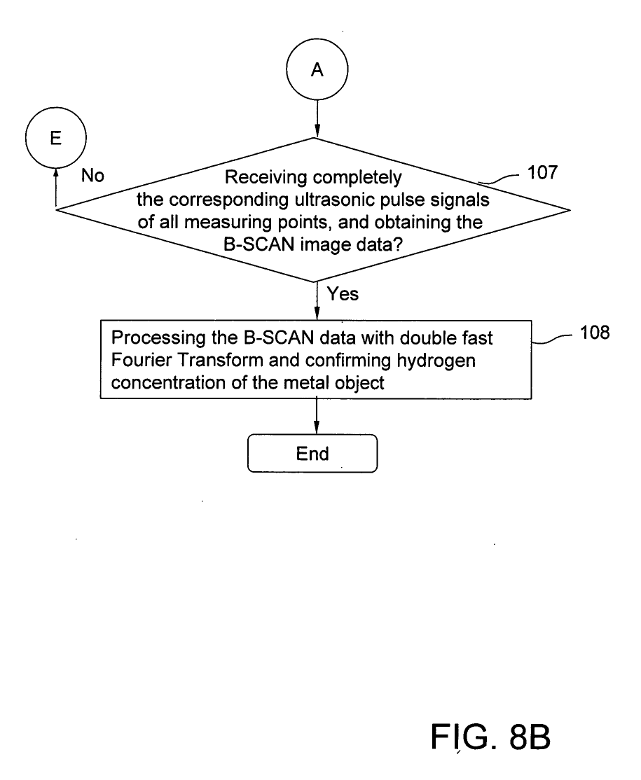

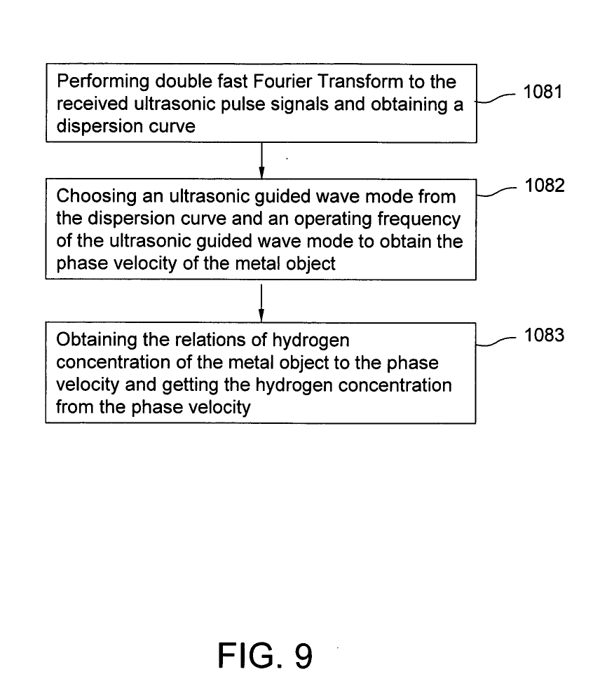

The flowchart of the hydrogen concentration detection method according to the invention is shown in FIG. 8. The method includes the following steps:
Step 101: setting a detection displacement. The displacement is the relative distance of the transmitting portion of the ultrasonic pulse signal transducer to the metal object in the coupling fluid;
Step 102: parting the displacement to get several measuring points;
Step 103: moving the transducer to a measuring point;
Step 104: transmitting ultrasonic pulse signals to the metal object;
Step 105: the metal object reflects ultrasonic pulse signals. The ultrasonic pulse signals pass along the NN and SGS paths and interfere. The ultrasonic pulse signals directly pass and reflect via the coupling fluid in the NN path. As shown in FIG. 1, the transducer 20 transmits a guide wave of ultrasonic pulse signal along the metal object 40. The guide wave moves through the coupling fluid 11 to the transducer 20 along the SGS path;
Step 106: receiving and storing the reflected ultrasonic pulse signals;
Step 107: repeating the steps 103 to 106 till receiving completely the corresponding ultrasonic pulse signals of all measuring points, and obtaining the B-SCAN image data; and
Step 108: processing the B-SCAN data with double fast Fourier Transform and confirming hydrogen concentration of the metal object. FIG. 9 illustrates the following processes:
Step 1081: performing double fast Fourier Transform to the received ultrasonic pulse signals and obtaining a dispersion curve. Similar to FIG. 5, the first fast Fourier Transform relates to time transformation. The second fast Fourier Transform relates to transformation of relative distance of the transmitting portion of the transducer to the metal object;
Step 1082: choosing an ultrasonic guided wave mode from the dispersion curve and an operating frequency of the ultrasonic guided wave mode to obtain the phase velocity of the metal object. The ultrasonic guided waves mode is usually chosen with a foundation ultrasonic guide wave that includes most ultrasonic waves energy; and
Step 1083: obtaining the relations (as shown in FIG. 7) of hydrogen concentration of the metal object to the phase velocity and getting the hydrogen concentration from the phase velocity.

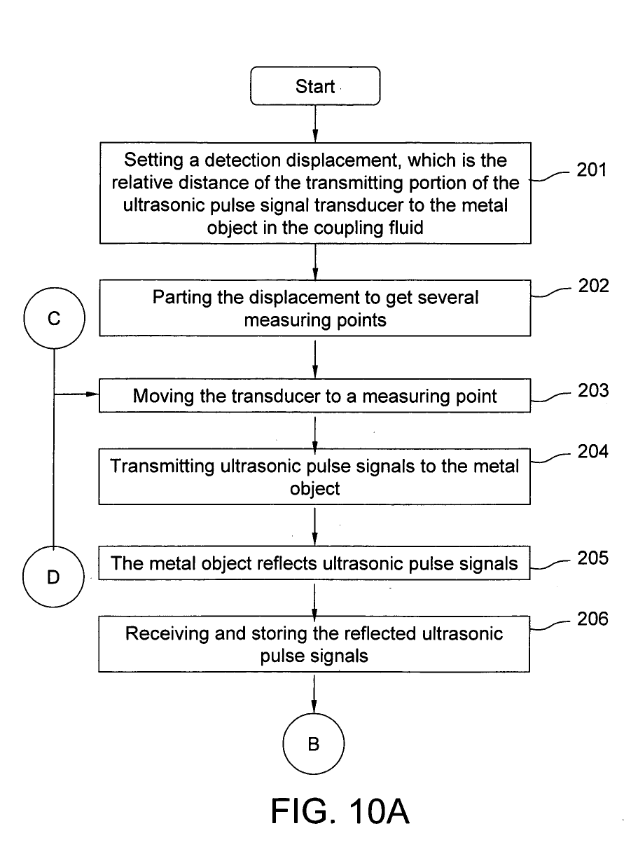

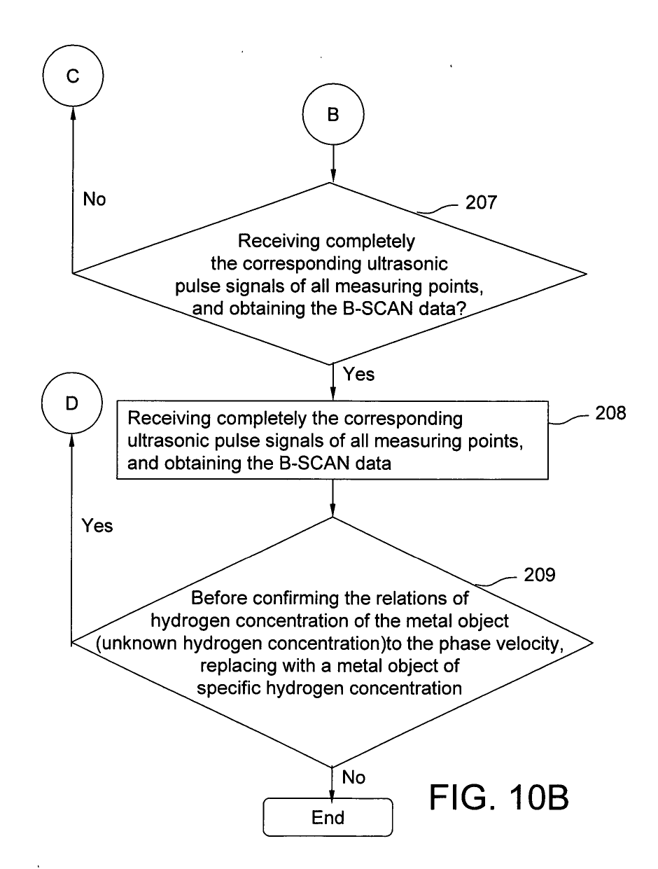

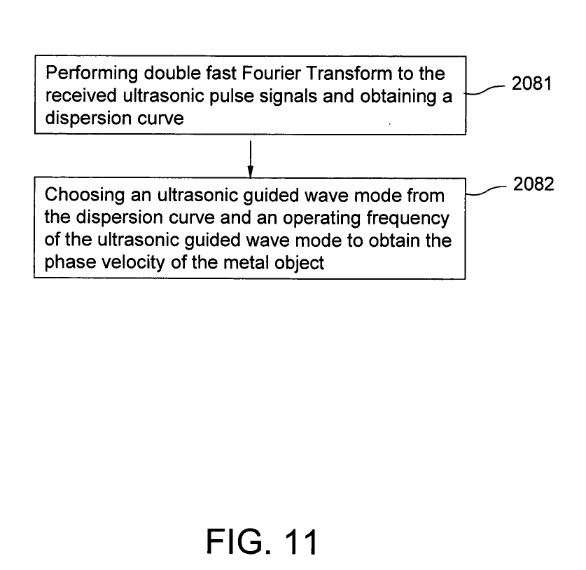

As for the step of obtaining the relations of hydrogen concentration of the metal object to the phase velocity, detailed flowcharts are shown in FIGS. 10A and 10B and described below:
Step 201: setting a detection displacement. The displacement is the relative distance of the transmitting portion of the ultrasonic pulse signal transducer to the metal object in the coupling fluid. The metal object contains a certain hydrogen concentration;
Step 202: parting the displacement to get several measuring points;
Step 203: moving the transducer to a measuring point;
Step 204: transmitting ultrasonic pulse signals to the metal object;
Step 205: the metal object reflects ultrasonic pulse signals. The ultrasonic pulse signals pass along the NN and SGS paths and interfere. The ultrasonic pulse signals directly pass and reflect via the coupling fluid in the NN path. As shown in FIG. 1, the transducer 20 transmits a guide wave of ultrasonic pulse signal along the metal object 40. The guide wave moves by way of the coupling fluid 11 to the transducer 20 along the SGS path;
Step 206: receiving and storing the reflected ultrasonic pulse signals;
Step 207: repeating the steps 203 to 206 till receiving completely the corresponding ultrasonic pulse signals of all measuring points, and obtaining the B-SCAN data; and
Step 208: processing the B-SCAN data with double fast Fourier Transform and obtaining the relations of hydrogen concentration to phase velocity under a fixed operating frequency of the metal object. As shown in FIG. 11, a detailed flowchart is described below.
Step 2081: performing double fast Fourier Transform to the received ultrasonic pulse signals and obtaining a dispersion curve. Similar to FIG. 5, the first fast Fourier Transform relates to time transformation. The second fast Fourier Transform relates to transformation of relative distance of the transmitting portion of the transducer to the metal object;
Step 2082: choosing an ultrasonic guided wave mode from the dispersion curve and an operating frequency of the ultrasonic guided wave mode to obtain the phase velocity of the metal object. The ultrasonic guided waves mode is usually chosen with a foundation ultrasonic guide wave that includes most ultrasonic waves energy.
Step 209: before confirming the relations of hydrogen concentration of the metal object (unknown hydrogen concentration) to the phase velocity, replacing with a metal object of specific hydrogen concentration (as shown in FIG. 7). Repeat the steps 203 to 208 till confirming the relation of hydrogen concentration to phase velocity of the metal object.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A system for detecting hydrogen concentration of a metal object, comprising:
a water tank, for storing a coupling fluid and mounting said metal object;
a transducer, placed aside said metal object for transmitting and receiving ultrasonic pulse signals to and reflected from said metal object, and being movable to predetermined positions; and
an electronic device, connected with said transducer and comprising means for controlling transmission and receiving of ultrasonic pulse signals through said transducer, movement of said transducer, and processing said received ultrasonic pulse signals with double fast Fourier Transform to get said hydrogen concentration of said metal object.

2. A system for detecting hydrogen concentration of a metal object according to claim 1 wherein said transducer is a line-focused-beam transducer.

3. A system for detecting hydrogen concentration of a metal object according to claim 1 wherein said transducer is made of polyvinylidene fluoride (PVDF) piezoelectric membrane.

4. A system for detecting hydrogen concentration of a metal object according to claim 1 wherein said transducer has a focus length in a range of 15 to 25 millimeters.

5. A system for detecting hydrogen concentration of a metal object according to claim 1 wherein said transducer works with frequency within 1 to 10 million Hertz, and with central frequency around 3.5 million Hertz.

6. A system for detecting hydrogen concentration of a metal object according to claim 1 wherein said electronic device comprises a data processor for processing data.

7. A system for detecting hydrogen concentration of a metal object according to claim 6 wherein said electronic device further comprises an analog/digital converter connected to said data processor for transforming and transferring said ultrasonic pulse signals between digital and analog forms.

8. A system for detecting hydrogen concentration of a metal object according to claim 6 wherein said electronic device further comprises an ultrasound pulser/receiver connected with said analog/digital converter and said transducer for generating said ultrasonic pulse signals.

9. A system for detecting hydrogen concentration of a metal object according to claim 6 wherein said electronic device further comprises a stepping motor controller and a stepping motor, said stepping motor controller and said data processor are connected for controlling said stepping motor moving said receiver to predetermined positions and changing relative distance of said transducer to said metal object.

10. A system for detecting hydrogen concentration of a metal object according to claim 1 wherein said water tank is formed with a hole and a plurality of fixtures for fixing said metal object.

11. A system for detecting hydrogen concentration of a metal object according to claim 1 wherein said water tank, said transducer and said electronic device are portable.

12. A method for detecting hydrogen concentration of a metal object, comprising steps of:
A) setting a detection displacement, said displacement is a relative distance of a transmitting portion of an ultrasonic pulse signal transducer to said metal object in a coupling fluid;
B) parting said displacement into a plurality of measuring points;
C) moving said transducer to a measuring point;
D) transmitting ultrasonic pulse signals to said metal object;
E) reflecting ultrasonic pulse signals from said metal object;
F) receiving and storing said reflected ultrasonic pulse signals;
G) repeating steps C) to F) till receiving completely corresponding ultrasonic pulse signals of all measuring points, and obtaining B-SCAN data; and
H) processing said B-SCAN data with double fast Fourier Transform and obtaining hydrogen concentration of said metal object.

13. A method for detecting hydrogen concentration of a metal object according to claim 12 wherein said reflected ultrasonic pulse signals in said step E) are interference signals of ultrasonic pulse signals directly reflected from said metal object and a guide wave of ultrasonic pulse signal moving along said metal object.

14. A method for detecting hydrogen concentration of a metal object according to claim 12 wherein said step H) further comprises steps of:
a) performing double fast Fourier Transform to said received ultrasonic pulse signals and obtaining a dispersion curve;
b) choosing an ultrasonic guided wave mode from said dispersion curve and an operating frequency of said ultrasonic guided wave mode to obtain a phase velocity of said metal object; and
c) obtaining relations of hydrogen concentration to phase velocity of a metal object and getting hydrogen concentration from said phase velocity.

15. A method for detecting hydrogen concentration of a metal object according to claim 14 wherein said double fast Fourier Transform in step a) comprises a first fast Fourier Transform relating to time transformation, and a second fast Fourier Transform relating to transformation of relative distance of said transmitting portion of said transducer to said metal object.

16. A method for detecting hydrogen concentration of a metal object according to claim 14 wherein said ultrasonic guided waves mode in step b) is a foundation ultrasonic guide wave.

17. A method for detecting hydrogen concentration of a metal object according to claim 14 wherein said relations of hydrogen concentration to phase velocity of a metal object in step c) is obtained by steps of:
1) setting a detection displacement, said displacement is a relative distance of a transmitting portion of an ultrasonic pulse signal transducer to a metal object in a coupling fluid;
2) parting said displacement to get a plurality of measuring points;
3) moving the transducer to a measuring point;
4) transmitting ultrasonic pulse signals to said metal object;
5) reflecting ultrasonic pulse signals from said metal object;
6) receiving and storing said reflected ultrasonic pulse signals;
7) repeating said steps 3) to 6) till receiving completely corresponding ultrasonic pulse signals of all measuring points, and obtaining B-SCAN data of said metal object;
8) processing said B-SCAN data with double fast Fourier Transform and obtaining relations of hydrogen concentration to phase velocity under a fixed operating frequency of said metal object; and
9) replacing with a metal object of specific hydrogen concentration and repeating said steps 3) to 8) till confirming relation of hydrogen concentration to phase velocity of said metal object.

18. A method for detecting hydrogen concentration of a metal object according to claim 17 wherein said step 8) further comprises steps of:
a) performing double fast Fourier Transform to said received ultrasonic pulse signals and obtaining a dispersion curve of said metal object;
b) choosing an ultrasonic guided wave mode from said dispersion curve and an operating frequency of said ultrasonic guided wave mode to obtain a phase velocity of said metal object.

19. A method for detecting hydrogen concentration of a metal object according to claim 18 wherein said double fast Fourier Transform in step a) comprises a first fast Fourier Transform relating to time transformation, and a second fast Fourier Transform relating to transformation of relative distance of said transmitting portion of said transducer to said metal object.

20. A method for detecting hydrogen concentration of a metal object according to claim 18 wherein said ultrasonic guided wave mode in step b) is chosen with a foundation ultrasonic guide wave including most ultrasonic waves energy.
